(19) United States
(12) Patent Application Publication
(10) Pub. No.: US 2003/0149145 A1
(43) Pub. Date: Aug. 7, 2003

(54) Flameproofed molding compositions

(76) Inventors: Matthias Bienmuller, Krefeld (DE); Michael Wagner, Moers (DE)

Correspondence Address: BAYER POLYMERS LLC, 100 BAYER ROAD, PITTSBURGH, PA, 15205, US

(21) Appl. No.: 10/309,835

(22) Filed: Dec. 4, 2002

(30) Foreign Application Priority Data
Dec. 7, 2001 (DE) 10160138.7

(51) Int. Cl. C08K 5/51

(52) U.S. Cl. 524/136

(57) ABSTRACT

An un-reinforced thermoplastic molding composition suitable for the production of fibers, films and molded articles is disclosed. The inventive composition contains polyester, melamine cyanurate, a phosphorus-containing flameproofing agent, an ester or amide of saturated or unsaturated aliphatic carboxylic acids with 10 to 40 C atoms with aliphatic saturated alcohols or amines with 2 to 40 C atoms, and processing auxiliary substances.

### FIELD OF THE INVENTION

The invention is directed to thermoplastic molding compositions and more particularly to flame resistant compositions containing polyesters.

### SUMMARY OF THE INVENTION

A non-reinforced and unfilled thermoplastic molding composition consisting of

A) 55 to 93.99 wt. % of a or a mixture of polyester,

B) 3 to 15 wt. % of melamine cyanurate,

C) 3 to 15 wt. % of at least one phosphorus-containing flameproofing agent in which the valence of the phosphorus is −3 to +5,

D) 0.01 to 5 wt. % of at least one ester or amide of saturated or unsaturated aliphatic carboxylic acids With 10 to 40 C atoms with aliphatic saturated alcohols or amines with 2 to 40 C atoms,

E) 0 to 10 wt. % of at least one member selected from the group consisting of stabilizers, antioxidants, thermal stabilizers, UV stabilizers, lubricants, mold release agents, rubber-elastic polymers, colorants, nucleating agents and plasticizers,

is disclosed.

The inventive composition that is characterized in its attractive combination of properties is suitable for use in the production of fibers, films and molded articles.

### BACKGROUND OF THE INVENTION

There is an increasing market interest in halogen-free flameproofed polyesters. Essential requirements that flameproofing agents have to meet include, inter alia, light intrinsic color, sufficient temperature stability for incorporation in thermoplastic materials, as well as their flameproofing effectiveness with, at the same time, good mechanical properties of the flameproofed molding compositions.

Apart from the halogen-containing systems, in principle four halogen-free flame-retardant systems are used in thermoplastic materials:

Inorganic flameproofing agents, which have to be used in large amounts in order to be effective.

Nitrogen-containing flame-retardant systems, such as melamine cyanurate, which are of limited effectiveness in thermoplastic materials such as, for example, polyamide. In reinforced polyamide, such systems are effective only in combination with short glass fibers. Melamine cyanurate alone is not effective in polyesters.

Phosphorus-containing flame-retardant systems, which are generally not effective in polyesters.

Phosphorus-containing/nitrogen-containing flame-retardant systems, such as, for example, ammonium polyphosphates or melamine phosphates, which do not have a sufficient thermal stability for use with thermoplastic materials that are processed at temperatures above 200° C.

From JP-A 03/281 652 polyalkylene terephthalates are known that contain melamine cyanurate and glass fibers as well as a phosphorus-containing flameproofing agent. These molding compositions contain derivatives of phosphoric acid such as phosphoric acid esters (valency state+5), which tend to “bleed” under thermal stress.

EP-A 0932643 also describes flameproofed polyester molding compositions that have been rendered flame-inhibiting with a combination of phosphorus-containing flameproofing agents and melamine cyanurate.

Flow properties are, however, adversely affected by large contents of fillers (reinforcing, flameproofing additives). Good flow properties are, however, of great importance specifically for thin-wall applications.

### DETAILED DESCRIPTION OF THE INVENTION

The object of the present invention is to provide a non-reinforced and unfilled, flameproofed polyester molding composition containing additives specifically targeted at the flameproofing effect and the mechanical properties, which are also suitable for thin-wall applications, this term being understood to mean molded parts that may be produced from the molding compositions according to the invention and whose wall thicknesses are ≦1.6 mm, preferably ≦1.0 mm.

It has surprisingly been found that a suitable requirement profile as regards flameproofing (e.g., at least UL94-V2, incandescent wire strength GWFI 960° C.) and mechanical properties (impact strength) may be established in non-reinforced polyester molding compositions compared to corresponding reinforced molding compositions by using significantly reduced amounts of at least one phosphorus-containing flameproofing agent in combination with melamine cyanurate and at least one ester or amide of saturated or unsaturated aliphatic carboxylic acids with 10 to 40 C atoms with aliphatic saturated alcohols or amines with 2 to 40 C atoms, and in addition, the molding compositions are also suitable for thin-wall applications.

The present invention accordingly provides a non-reinforced and unfilled thermoplastic molding composition consisting of

| | | |
|---|---|---|
| A) | 55 to 93.99 wt. % of | a or a mixture of polyester, |
| B) | 3 to 15 wt. % of | melamine cyanurate, |
| C) | 3 to 15 wt. % of | at least one phosphorus-containing flameproofing |
| | | agent, |
| D) | 0.01 to 5 wt. % of | at least one ester or amide of saturated or |
| | | unsaturated aliphatic carboxylic acids with 10 to 40 C |
| | | atoms with aliphatic saturated alcohols or amines |
| | | with 2 to 40 C atoms, |
| E) | 0 to 10 wt. % of | processing auxiliary substances selected from the |
| | | group consisting of stabilizers, antioxidants, thermal |
| | | stabilizers and ultraviolet light stabilizers, lubricants |
| | | and mold release agents, rubber-elastic polymers |
| | | (also termed impact strength modifiers), colorants, |
| | | preferably dyes and pigments, nucleating agents and |
| | | plasticizers, |

in which the total sum of the percentages by weight of the components. A) to E) is 100%.

Suitable flameproofing agent C) includes phosphine oxide of the general formula (I)

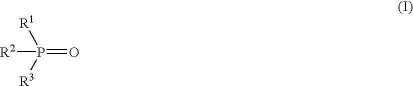

in which

R¹, R² and R³ denote identical or different alkyl, aryl, alkylaryl or cycloalkyl groups with 8 to 40 C atoms.

The preferred thermoplastic molding compositions according to the invention contains as flameproofing agent C at least one compound of the general formula

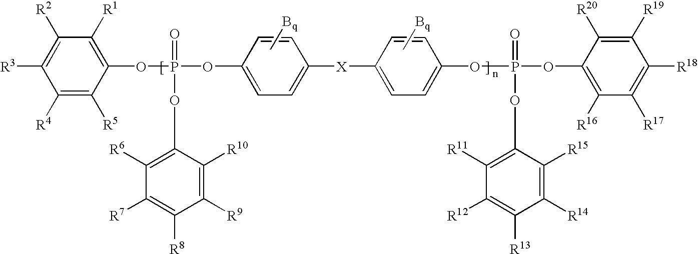

in which

R¹ to R²⁰ independently of one another denote hydrogen, a linear or branched alkyl group with up to 6 C atoms,

n has an average value of 0.5 to 50, and

B denotes C₁ to C₁₂-alkyl, preferably methyl, or halogen, preferably chlorine or bromine,

q independently of one another is 0, 1 or 2,

X denotes a single bond, C═O, S, O, SO₂, C(CH₃)₂, C₁ to C₅-alkylene, C₂ to C₅-alkylidene, C₅ to C₆-cycloalkylidene, C₆ to C₁₂-arylene, onto which further aromatic rings optionally containing heteroatoms may be condensed, or denotes a radical of the formula (II) or (III)

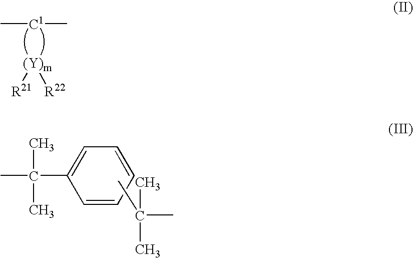

where Y denotes carbon and

R²¹ and R²², are selected individually for each Y, independently of one another denote hydrogen or C₁ to C₆-alkyl, preferably hydrogen, methyl or ethyl,

m is 4 to 7, preferably 4 or 5, with the proviso that on at least one atom Y, R²¹ and R²² are simultaneously alkyl. Those phosphorus compounds of the formula are preferred in which R¹ to R²⁰ independently of one another denote hydrogen or a methyl radical and in which q=0. Particularly preferred are compounds in which X denotes SO₂, O, S, C═O, C₂-C₅-alkylidene, C₅ to C₆-cycloalkylidene or C₆ to C₁₂-arylene. Compounds where X═C(CH₃)₂ are most particularly preferred.

The present invention furthermore provides thermoplastic molding compositions in which the component C) contains one or more of triphenyl phosphine oxide, triphenyl phosphine sulfide, triphenyl phosphate, resorcinol-bis(diphenyl phosphate), triphenyl phospine or, most particularly preferably, bisphenol A diphosphate.

The molding compositions according to the invention contain as component (A) 55 to 93.99 wt. %, preferably 65 to 93 wt. % and in particular 75 to 93 wt. % of a or a mixture of thermoplastic polyester,

Suitable polyesters include those based on aromatic dicarboxylic acids and an aliphatic or aromatic dihydroxy compound.

A first group of preferred polyesters are polyalkylene terephthalates with 2 to 10 C atoms in the alcohol part.

Such polyalkylene terephthalates are polyalkylene terephthalates with 2 to 10 C atoms in the alcohol part.

Such polyalkylene terephthalates are known per se and are described in the literature. They contain an aromatic ring in the main chain, which is derived from the aromatic dicarboxylic acid. The aromatic ring may also be substituted, for example, by halogen such as chlorine and bromine, or by C₁ to C₄-alkyl groups such as methyl, ethyl, i-propyl, n-propyl and n-butyl, i-butyl and t-butyl groups.

These polyalkylene terephthalates may be produced in a manner known per se by reacting aromatic dicarboxylic acids, their esters or other ester-forming derivatives with aliphatic dihydroxy compounds.

Preferred dicarboxylic acids that may be mentioned include 2,6-naphthalenedicarboxylic acid, terephthalic acid and isophthalic acid or their mixtures. Up to 30 mole %, preferably not more than 10 mole % of the aromatic dicarboxylic acids may be replaced by aliphatic or cycloaliphatic dicarboxylic acids such as adipic acid, azelaic acid, sebacic acid, dodecanedioic acids and cyclohexanedicarboxylic acids.

Of the aliphatic dihydroxy compounds, diols with 2 to 6 carbon atoms are preferred, in particular 1,2-ethanediol, 1,4-butanediol, 1,6-hexanediol, 1,4-hexanediol, 1,4-cyclohexanediol, 1,4-cyclohexanedimethanol and neopentyl glycol or their mixtures.

Particularly preferred polyesters (A) that may be mentioned are polyalkylene terephthalates that are derived from alkanediols with 2 to 6 C atoms. Of these, polyethylene terephthalate and polybutylene terephthalate or their mixtures are particularly preferred.

The viscosity number of the polyesters (A) is generally in the range from 70 to 220, preferably 80 to 260, measured in a 0.5 wt. % solution in a phenol/o-dichlorobenzene mixture (weight ratio 1:1) at 25° C.

Particularly preferred are polyesters whose carboxyl terminal group content is up to 100 mval/kg, preferably up to 50 mval/kg and in particular up to 40 mval/kg. Such polyesters may be produced for example according to the process disclosed in DE-A 44 01 055. The carboxyl group terminal content is normally determined by titration methods (e.g. potentiometric titration).

Particularly preferred molding compositions contain as component A) a mixture of polyethylene terephthalate (PET) and polybutylene terephthalate (PBT). The proportion of polyethylene terephthalate in the mixture is preferably up to 50 wt. %, in particular 10 to 30 wt. %, referred to 100 wt. % of A).

Such molding compositions according to the invention exhibit very good flameproofing properties and improved mechanical properties.

It is also advantageous to use PET recyclates (also termed scrap PET) mixed with polyalkylene terephthalates such as PBT.

By the term recyclates there are understood in general:

1) So-called post-industrial recyclate: this is production waste from the polycondensation or processing, e.g., sprue waste from injection molding processing, start-up materials from injection molding processing or extrusion, or edge sections of extruded sheets or films.

2) Post-consumer recyclate: this covers plastics articles that have been collected and reprocessed by the end user after use. By far the most common articles in terms of quantity are PET bottles for mineral water, soft drinks and juices.

Both types of recyclate may be present either as ground material or in the form of granules. In the latter case the raw recyclates are melted and granulated in an extruder after they have been separated and cleaned. The handling, pourability and metering ability for further processing steps are thereby facilitated.

Recyclates present in the form of granules as well as ground material may be used, in which connection the maximum longitudinal dimension of the particle size should be 6 mm, preferably less than 5 mm.

On account of the hydrolytic scission of polyesters during processing (due to traces of moisture) it is recommended to dry the recyclate before use in the context of the invention. The residual moisture content after drying is preferably 0.01 to 0.7%, in particular 0.2 to 0.6%.

A further suitable group of recyclates are fully aromatic polyesters derived from aromatic dicarboxylic acids and aromatic dihydroxy compounds.

Suitable as aromatic dicarboxylic acids include mixtures of 5 to 100 mole % isophthalic acid and 0 to 95 mole % terephthalic acid, in particular mixtures of about 80% terephthalic acid with 20% isophthalic acid up to roughly equivalent mixtures of these two acids are used, the percents being relative to the moles of the acid component.

The aromatic dihydroxy compounds preferably have the general formula (I)

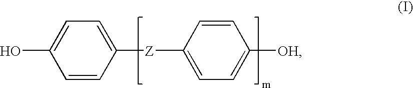

in which Z denotes an alkylene or cycloalkylene group with up to 8 C atoms, an arylene group with up to 12 C atoms, a carbonyl group, a sulfonyl group, an oxygen or sulfur atom or a chemical bond, and m is 0 to 2. The compounds (I) may contain C₁-C₆-alkyl groups or alkoxy groups and fluorine, chlorine or bromine as substituents on the phenylene groups.

The following may be named as parent substances of these compounds

dihydroxydiphenyl,

di-(hydroxyphenyl)alkane,

di-(hydroxyphenyl)cycloalkane,

di-(hydroxyphenyl)sulfide,

di-(hydroxyphenyl)ether,

di-(hydroxyphenyl)ketone,

di-(hydroxyphenyl)sulfoxide,

α,α′-di-(hydroxyphenyl)dialkylbenzene,

di-(hydroxyphenyl)-sulfone, di-(hydroxyphenyl)benzene, resorcinol and hydroquinone, as well as their nuclear-alkylated or nuclear-halogenated derivatives.

Of these

4-dihydroxydiphenyl,

2,4-di-(4′-hydroxyphenyl)-2-methylbutane,

α,α′-di-(3′-methyl4′-hydroxyphenyl)propane and

2,2-di-(3′-chloro4′-hydroxyphenyl)propane are preferred,

and

2,2-di-(4′-hydroxyphenyl)propane,

2,2-di-(3′,5-dichlorodihydroxyphenyl)propane,

1,1-di-(4′-hydroxyphenyl )cyclohexane,

3,4-dihydroxybenzophenone,

4,4′-dihydroxy-diphenylsulfone and

2,2-di-(3′,5′-dimethyl4′-hydroxyphenyl)propane or their mixtures are particularly preferred.

Mixtures of polyalkylene terephthalates and fully aromatic polyesters may also be used. These may contain 20 to 98 wt. % of the polyalkylene terephthalate and 2 to 80 wt. % of the fully aromatic polyester.

Polyesters within the meaning of the present invention are also understood to include mixtures with polycarbonates that are obtained by polymerization of aromatic dihydroxy compounds, in particular, bis-(4-hydroxyphenyl)2,2-propane (bisphenol A) or their derivatives, e.g., with phosgene. Corresponding products are known per se and are described in the literature, and for the most part may also be obtained commercially. The amount of polycarbonates (in the mixture with polyester) is up to 90 wt. %, preferably up to 50 wt. %, referred to 100 wt. % of component (A).

Polyester block copolymers such as copolyether esters may also be used. Such products are known per se and are described in the literature, for example in U.S. Pat. No. 3,651,014. Corresponding products are also commercially available, e.g. Hytrel® (DuPont).

As component B) the thermoplastic molding compositions according to the invention contain 3 to 15 wt. %, preferably 3 to 10 wt. % and in particular 3 to 6 wt. % of melamine cyanurate as flameproofing agent.

The melamine cyanurate used according to the invention (component B) is a reaction product of preferably equimolar amounts of melamine (formula (I)) and cyanuric acid or isocyanuric acid (formulae (IIa) and (IIb)).

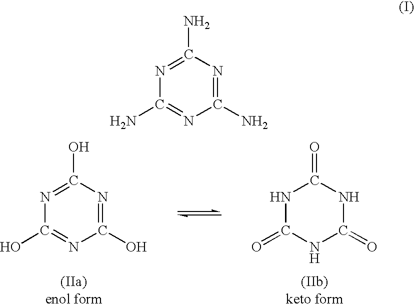

This is obtained for example by reacting aqueous solutions of the starting compounds at 90° to 100° C. The commercially available product is a white powder with a mean grain size d₅₀ of 1.5 to 7 μm.

Suitable flameproofing agents C) are contained in the molding compositions according to the invention in amounts of 3 to 15 wt. %, preferably 3 to 10 wt. % and particularly preferably 3 to 6 wt. %, referred to the total weight of the components A) to E).

Component C) are organic and/or inorganic phosphorus-containing compounds in which the phosphorus has a valency state of −3 to +5. The valency state is understood to mean the term “oxidation state” as defined on pages 166 to 177 in “Lehrbuch der Anorganischen Chemie” by A. F. Hollemann and E. Wiberg, Walter des Gruyter & Co. (1964, 57^{th} to 70^{th} Edition). Phosphorus compounds of valency states −3 to +5 are derived from phosphine (−3), diphosphine (−2), phosphine oxide (−1), elementary phosphorus (+0), hypophosphorous acid (+3), hypodiphosphoric acid (+4) and phosphoric acid (+5).

Examples of phosphorus compounds of the phosphine class that have a valency state of −3 are aromatic phosphines such as triphenylphosphine, tritolylphosphine, trionylphosphine, trinaphthylphosphine, etc. Triphenylphosphine is particularly preferred.

Examples of phosphorus compounds of the diphosphine class that have a valency state of −2 are tetraphenyldiphosphine, tetranaphthyidiphosphine, etc. Tetranaphthyldiphosphine is particularly suitable. Phosphorus compounds of the valency state −1 are derived from phosphine oxide.

Phosphine oxides of the general formula

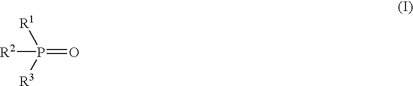

are suitable, in which

R¹, R² and R³ denote identical or different alkyl, aryl, alkylaryl or cycloalkyl groups with 8 to 40 C atoms.

Examples of phosphine oxides include triphenylphosphine oxide, tritolylphosphine oxide, trisnonylphenylphosphine oxide, tricyclohexylphosphine oxide, tris-(n-butyl)phosphine oxide, tris-(n-hexyl)phosphine oxide, tris-(n-octyl)-phosphine oxide, tris-(cyanoethyl)phosphine oxide, benzylbis(cyclohexyl) phosphine oxide, benzylbisphenyl-phosphine oxide, tricyclohexylphosphine oxide and tris-(n-octyl)phosphine oxide.

Also suitable is triphenylphosphine sulfide and its derivatives of phosphine oxides as described above.

Phosphorus of valency state ±0 is elemental phosphorus, which includes both red and black phosphorus. Red phosphorus is preferred.

Phosphorus compounds of the “oxidation state” +1 include hypophosphites. They may have the character of a salt or may be purely organic in nature. Examples include calcium hypophosphite and magnesium hypophosphite, as well as double hypophosphites or complex hypophosphites, or organic hypophosphites such as cellulose hypophosphite esters, esters of hypophosphorous acids with diols, such as for example 1,10-dodecyldiol. Substituted phospinic acid and its anhydrides, such as for example diphenylphosphinic acid, may also be used. Moreover di-p-tolylphosphinic acid and di-cresylphosphinic anhydride are also suitable. Other suitable compounds include hydroquinone-bis(diphenylphosphinic acid) esters, ethylene glycol-bis(diphenylphosphinic acid) esters, propylene glycol-bis(diphenylphosphinic acid) esters, etc. Also suitable are aryl(alkyl)phosphinic acid amides, such as diphenylphosphinic acid dimethylamide and sulfon-amidoaryl(alkyl)phosphinic acid derivatives such as p-tolylsulfonamidodiphenyl-phosphinic acid. Hydroquinone-bis-(diphenylphosphinic acid) esters and ethylene glycol-bis-(diphenylphosphinic acid) esters and the bisphenyl phosphinate of hydroquinone are preferably used.

Phosphorus compounds of the oxidation state +3 are derived from phosphorous acid. Suitable cyclic phosphonates include the ones derived from pentaerythritol, neopentyl glycol or pyrocatechol. Phosphorus in the valency state +3 also include triaryl(alkyl) phosphites, such as triphenyl phosphite, tris(4-decylphenyl) phosphite, tris(2,4-di-tert.-butylphenyl) phosphite or phenyidodecyl phosphite, etc. Also suitable are diphosphites such as propylene glycol-1,2-bis-(diphosphite) or cyclic phosphites that are derived from pentaerythritol, neopentyl glycol or pyrocatechol.

Particularly preferred are methylneopentyl glycol phosphonate and phosphite, as well as dimethylpentaerythritol diphosphonate and phosphite.

As phosphorus compounds in the oxidation state +4, hypodiphosphates such as tetraphenyl hypodiphosphate or bisneopentyl hypodiphosphate are most suitable.

As phosphorus compounds in the oxidation state +5 suitable above all are alkyl-substituted and aryl-substituted phosphates. Examples include phenyl-bisdodecyl phosphate, phenylethyl hydrogen phosphate, phenyl-bis(3,5,5-trimethylhexyl) phosphate, ethyldiphenyl phosphate, 2-ethylhexyldi(tolyl) phosphate, diphenyl hydrogen phosphate, bis(2-ethylhexyl)-p-tolyl phosphate, tritolyl phosphate, bis(2-ethylhexyl)phenyl phosphate, di(nonyl)phenyl phosphate, phenylmethyl hydrogen phosphate, di(dodecyl)-p-tolyl phosphate, p-tolyl-bis(2,5,5-trimethylhexyl) phosphate or 2-ethylhexyldiphenyl phosphate. Particularly suitable are phosphorus compounds in which each radical is an aryloxy radical.

Suitable inter alia are triphenyl phosphate and resorcinol bis-(diphenyl phosphate) and their nuclear-substituted derivatives of the general formula

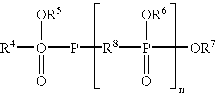

in which the substituents have the following meanings:

R⁴, R⁷ denotes an aromatic radical with 6 to 20 C atoms, preferably a phenyl radical, which may be substituted with alkyl groups with 1 to 4 C atoms, preferably methyl,

R⁸ denotes a difunctional phenol, preferably

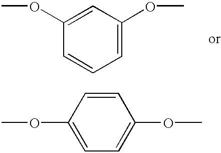

and n=1 to 100. preferably 1 to 5.

Most particularly preferred in this connection are phosphorus compounds of the formula.

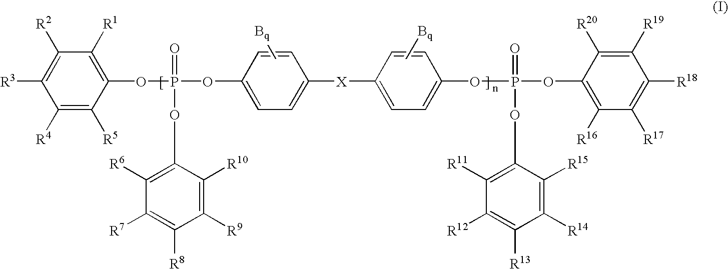

in which

R¹ to R²⁰ independently of one another denote hydrogen or a linear or branched alkyl group with up to 6 C atoms

n has an average value of 0.5 to 50 and

B denotes C₁-C₁₂-alkyl, preferably methyl, or halogen, preferably chlorine or bromine,

q independently of one another is 0, 1 or 2,

X is a single bond, C═O, S, O, SO₂, C(CH₃)₂, C₁-C₅-alkylene, C₂-C₅-alkylidine, C₅-C₆-cycloalkylidene, C₆-C₁₂-arylene, onto which may be condensed further aromatic rings optionally containing heteroatoms, or a radical of the formula (II) or (III)

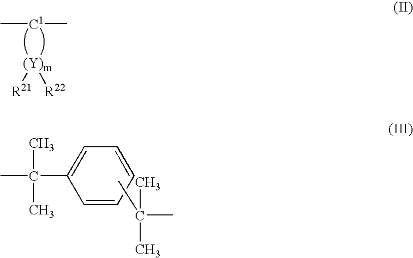

where Y denotes carbon and

R²¹ and R²², individually selected for each Y, and independently of one another denote hydrogen or C₁-C₆-alkyl, preferably hydrogen, methyl or ethyl,

m denotes a whole number of 4 to 7, preferably 4 or 5, with the proviso that on at least one Y atom, R²¹ and R²² are simultaneously alkyl.

Preferred are those phosphorus compounds of the formula (I) in which R¹ to R²⁰ independently of one another denote hydrogen or a methyl radical and in which q=0. Particularly preferred are compounds in which X denotes SO₂, O, S, C═O, C₂-C₅-alkylidene, C₅-C₆-cycloalkylidene or C₆-C₁₂-arylene. Compounds where X═C(CH₃)₂ are most particularly preferred.

The degree of oligomerization n is determined as the average value from the processes for producing the specified phosphorus-containing compounds. The degree of oligomerization n is less than 10. Preferred are compounds where n is from 0.5 to 5, particularly preferably 0.7 to 2.5. Most particularly preferred are compounds that have a high proportion of molecules with n=1 between 60% and 100%, preferably between 70% and 100%, particularly preferably between 79% and 100%. Depending on the production, the above compounds may also contain minor amounts of triphenyl phosphate. The amounts of this substance are generally less than 5 wt. %, in the present connection compounds are preferred whose triphenyl phosphate content is in the range from 0 to 5%, preferably from 0 to 4%, particularly preferably from 0 to 2.5%, referred to the product employed according to formula (I).

The phosphorus compounds according to formula (I) are known (see for example EP-A 363 608, EP-A 640 655) or may be produced in a similar manner according to known methods (e.g. Ullmann's Encyklopädie der Technischen Chemnie, Vol. 18, p. 301 ff. 1979; Houben-Weyl, Methoden der Organischen Chemie, Vol. 12/1, p. 43; Beilstein Vol. 6, p. 177).

The bisphenol A diphosphate (also termed bisphenol A bis-diphenyl phosphate or tetraphenyl bisphenol A diphosphate, BDP) that is most particularly preferred within the scope of the present invention is commercially available and is obtainable as, inter alia, Fyroflex BDP (Akzo Nobel Chemicals BV, Amersfoort, Holland), Ncendex P-30 (Albemarle, Baton Rouge, La., USA), Reofos BAPP (Great Lakes, West Lafayette, Ind., USA) or CR 741 (Daihachi, Osaka, Japan).

Furthermore cyclic phosphates may also be used. Particularly suitable in this connection are diphenylpentaerythritol diphosphate and phenyl neopentyl phosphate.

Apart from the low molecular weight phosphorus compounds mentioned above, oligomeric and polymeric phosphorus compounds are also suitable.

Such polymeric, halogen-free organic phosphorus compounds With phosphorus in the polymer chain are formed for example in the production of pentacyclic, unsaturated phosphine dihalides, as is described for example in DE-A 20 36 173. The molecular weight, measured by vapour pressure osmometry in dimethylformamide, of the polyphospholine oxides should be in the range from 500 to 7,000, preferably in the range from 700 to 2,000.

The phosphorus has in this case the oxidation state −1.

In addition inorganic co-ordination polymers of aryl(alkyl)phosphinic acid, such as for example poly-beta-sodium (I)-methylphenyl phosphinate, may be used. Their production is described in DE-A 31 40 520. The phosphorus has an oxidation state of +1.

Moreover such halogen-free polymeric phosphorus compounds may be formed by the reaction of a phosphonic acid chloride such as phenylphosphonic, methyl phosphonic, propylphosphonic, styrylphosphonic or vinylphosphonic acid dichloride with bifunctional phenols such as for example hydroquinone, resorcinol, 2,3,5-trimethylhydroquinone, bisphenol A or tetramethylbisphenol A.

Further halogen-free polymeric phosphorus compounds that may be contained in the molding compositions according to the invention are produced by reaction of phosphoryl trichloride or phosphoric acid ester dichlorides with a mixture of monofunctional, bifunctional and trifunctional phenols and other compounds containing hydroxyl groups (see Houben-Weyl-Müller, Thieme-Verlag Stuftgart, Organische Phosphorverbindungen Part II (1963)). Polymeric phosphonates may also be produced by transesterification reactions of phosphonic acid esters with bifunctional phenols (see DE-A 29 25 208) or by reactions of phosphonic acid esters with diamines or diamides or hydrazides (see U.S. Pat. No. 4,403,075). The inorganic poly(ammonium phosphate) is also suitable.

There may also be used oligomeric pentaerythritol phosphites, phosphates and phosphonates according to EP-B 8 486, e.g. Mobil Antiblaze® 19 (registered trademark of Mobil Oil).

Component D) the molding compositions according to the invention is present in an amount of 0.01 to 5 wt. %, preferably 0.05 to 3 wt. % and in particular 0.1 to 2 wt. % of at least one ester or amide of saturated or unsaturated aliphatic carboxylic acids with 10 to 40, preferably 16 to 22 C atoms with aliphatic saturated alcohols or amines with 2 to 40, preferably 2 to 6 C atoms.

The carboxylic acids may be monobasic or dibasic. By way of example there may be mentioned pelargonic acid, palmitic acid, lauric acid, margaric acid, dodecanedioic acid, behenic acid and particularly preferably stearic acid, capric acid as well as montanic acid (mixture of fatty acids with 30 to 40 C atoms).

The aliphatic alcohols may be monohydric to tetrahydric. Examples of alcohols include n-butanol, n-octanol, stearyl alcohol, ethylene glycol, propylene glycol, neopentyl glycol and pentaerythritol, glycerol and pentaerythritol being preferred.

The aliphatic amines may be monofunctional to trifunctional. Examples include stearylamine, ethylenediamine, propylenediamine, hexamethylenediamine, di(6-aminohexyl)amine, ethylenediamine and hexamethylenediamine being particularly preferred. Preferred esters or amides are correspondingly glycerol distearate, glycerol tristearate, ethylenediamine distearate, glycerol monopalmitate, glycerol trilaurate, glycerol monobehenate and pentaerythritol tetrastearate.

Mixtures of various esters or amides may be used, or esters may be used in combination with amides, the mixing ratio being chosen as desired.

Component E) is present in the molding compositions according to the invention in an amount of 0 to 10 wt. %, especially 0 to 5 wt. %, most particularly preferably 0 to 3 wt. % of conventional additives and conventional processing auxiliary substances, which are selected from the following group:

Stabilizers, antioxidants, thermal stabilizers, ultraviolet light stabilizers, lubricants and mold release agents, rubber-elastic polymers (also termed impact modifiers), colorants, preferably dyes and pigments, nucleating agents and plasticizers,

Component E is understood to exclude reinforcing substances in general, glass fibers, glass spheres and further fiber-shaped or particulate reinforcing fillers of glass, carbon fibers, amorphous silicic acid, asbestos, magnesium carbonate, wollastonite, kaolin, chalk, mica, barium sulfate and feldspar.

Conventional additives E) include rubber-elastic polymers (often also termed impact modifiers), elastomers or rubbers.

In general E) comprises copolymers that are preferably built up from at least two of the following monomers: ethylene, propylene, butadiene, isobutene, isoprene, chloroprene, vinyl acetate, styrene, acrylonitrile and acrylic acid or methacrylic acid esters with 1 to 18 C atoms in the alcohol component.

Such polymers are described for example in Houben-Weyl, Methoden der Organischen Chemie, Vol. 14/1 (Georg Thieme-Verlag, Stuttgart 1961), pp. 392 to 406, and in the monograph by C. B. Bucknall, “Toughened Plastics” (Applied Science Publishers, London, 1977).

Some preferred types of such elastomers are mentioned hereinafter.

Preferred types of such elastomers are the so-called ethylene-propylene (EPM) or ethylene-propylene-diene (EPDM) rubbers.

In practice, EPM rubbers generally contain hardly any double bonds, whereas EPDM rubbers may contain 1 to 20 double bonds per 100 C atoms.

As diene monomers for EPDM rubbers there may for example be mentioned conjugated dienes such as isoprene and butadiene, non-conjugated dienes with 5 to 25 C atoms such as penta-1,4-diene, hexa-1,4-diene, hexa-1,5-diene, 2,5-dimethylhexa-1,5-diene and 2,5-dimethylocta-1,4-diene, cyclic dienes such as cyclopentadiene, cyclohexadienes, cyclooctadienes and dicyclopenta-diene as well as alkenyl norbornenes such as 5-ethylidene-2-norbornene, 5- butylidene-2-norbornene, 2-methallyl-5-norbornene, 2-isopropenyl-5-norbornene and tricyclodienes such as 3-methyltricyclo(5.2.1.0.2.6)-3,8-decadiene or their mixtures. Hexa-1,5-diene, 5-ethylidene norbornene and dicyclopentadiene are preferred. The diene content of the EPDM rubbers is preferably 0.5 to 50 wt. %, in particular 1 to 8 wt. %, referred to the total weight of the rubber.

EPM and EPDM rubbers may preferably also be grafted with reactive carboxylic acids or their derivatives. There may be mentioned here by way of example acrylic acid, methacrylic acid and their derivatives, e.g. glycidyl (meth)acrylate, as well as maleic anhydride.

A further group of preferred rubbers include copolymers of ethylene with acrylic acid and/or methacrylic acid and/or the esters of these acids. In addition the rubbers may also contain dicarboxylic acids such as maleic acid and fumaric acid or derivatives of these acids, for example esters and anhydrides, and/or monomers containing epoxy groups. These dicarboxylic acid derivatives or epoxy group-containing monomers are preferably incorporated into the rubber by addition, to the monomer mixture, of monomers containing dicarboxylic acid groups and/or epoxy groups of the general formula (I) or (II) or (III) or (IV)

R¹C(COOR²)═C(COOR³)R⁴ (I)

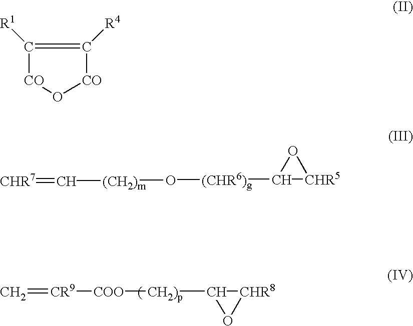

in which R¹ to R⁹ denote hydrogen or alkyl groups with 1 to 6 C atoms and m is a whole number from 0 to 20, g is a whole number from 0 to 10 and p is a whole number from 0 to 5.

Preferably the radicals R¹ to R⁹ denote hydrogen, m denotes 0 or 1 and g denotes 1. The corresponding compounds are maleic acid, fumaric acid, maleic anhydride, allyl glycidyl ether and vinyl glycidyl ether.

Preferred compounds of the formulae (I), (II) and (IV) are maleic acid, maleic anhydride and epoxy group-containing esters of acrylic acid and/or methacrylic acid such as glycidyl acrylate, glycidyl methacrylate and the esters with tertiary alcohols, such as t-butyl acrylate. Although the latter have no free carboxyl groups, their behaviour is similar to that of the free acids and they are therefore described as monomers having latent carboxyl groups.

Preferably the copolymers consist of 50 to 98 wt. % of ethylene, 0.1 to 20 wt. % of epoxy group-containing monomers and/or methacrylic acid and/or acid anhydride group-containing monomers, as well as the residual amount of (meth)acrylic acid esters.

Particularly preferred are copolymers of

50 to 98 wt. %, in particular 55 to 95 wt. % of ethylene,

0.1 to 40 wt. %, in particular 0.3 to 20 wt. % of glycidyl acrylate and/or glycidyl methacrylate, (meth)acrylic acid and/or maleic anhydride, and

1 to 45 wt. %, in particular 10 to 40 wt. % of n-butyl acrylate and/or 2-ethylhexyl acrylate.

Further preferred esters of acrylic acid and/or methacrylic acid are the methyl, ethyl, propyl and i-butyl and t-butyl esters.

In addition vinyl esters and vinyl-ethers may also be used as comonomers.

The aforedescribed ethylene copolymers may be produced by methods known per se, preferably by random copolymerization under high pressure and elevated temperature. Corresponding processes are generally known.

Preferred elastomers are also emulsion polymers, whose production is described for example by Blackley in the monograph “Emulsion Polymerization”. The emulsifiers and catalysts that may be used are known per se.

In principle homogeneously structured elastomers or also those having a shell structure may be employed. The shell-type structure is determined by the sequence of addition of the individual monomers; also, the morphology of the polymers is influenced by this sequence of addition.

Acrylates such as for example n-butyl acrylate and 2-ethylhexyl acrylate, corresponding methacrylates, butadiene and isoprene as well as their mixtures may be mentioned here simply by way of example as monomers for the production of the rubber part of the elastomers. These monomers may be copolymerized with further monomers, for example with styrene, acrylonitrile, vinyl ethers and further acrylates or methacrylates such as methyl methacrylate, methyl acrylate, ethyl acrylate and propyl acrylate.

The flexible or rubber phase (with a glass transition temperature of below 0° C.) of the elastomers may form the core, the outer cover or a middle shell (in the case of elastomers with a more than double-shell structure); with multi-shell elastomers several shells may also consist of a rubber phase.

If one or more rigid components (with glass transition temperatures of more than 20° C.) apart from the rubber phase are involved in the structure of the elastomer, then these are generally produced by polymerization of styrene, acrylonitrile, methacrylonitrile, α-methylstyrene, p-methylstyrene, acrylic acid esters and methacrylic acid esters such as methyl acrylate, ethyl acrylate and methyl methacrylate as principal monomers. In addition minor amounts of further comonomers may also be used in this connection.

In some cases it has proved advantageous to use emulsion that contain reactive groups on the surface. Such groups include for example epoxy, carboxyl, latent carboxyl, amino or amide groups as well as functional groups that may be incorporated by the co-use of monomers of the general formula

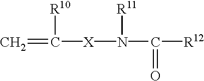

in which

R¹⁰ denotes hydrogen or a C₁- to C₄-alkyl group,

R¹¹ denotes hydrogen, a C₁- to C₈-alkyl group or an aryl group, in particular phenyl

R¹² denotes hydrogen, a C₁- to C₁₀-alkyl group, a C₆ to C₁₂-aryl group or —OR¹³

R¹³ denotes a C₁- to C₈-alkyl group or C₆- to C₁₂-aryl group, which may optionally be substituted with O-containing or N-containing groups,

X denotes a chemical bond, a C₁- to C₁₀-alkylene or C₆- to C₁₂-arylene group or

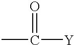

Y denotes O-Z or HN-Z, and

Z denotes a C₁- to C₁₀-alkylene or C₆- to C₁₂-arylene group.

The graft monomers described in EP-A 208 187 are also suitable for introducing reactive groups on the surface.

As further examples there may also be mentioned acrylamide, methacrylamide and substituted esters of acrylic acid or methacrylic acid such as (N-t-butylamino)-ethyl methacrylate, (N,N-dimethylamino)ethyl acrylate, (N,N-dimethylamino)methyl acrylate and (N,N-diethylamino)ethyl acrylate.

Furthermore the particles of the rubber phase may be crosslinked. Monomers acting as crosslinking agents include for example buta-1,3-diene, divinylbenzene, diallyl phthalate and dihydrodicyclopentadienyl acrylate as well as the compounds described in EP-A 50 265.

Moreover so-called graft-linking monomers may also be used, i.e. monomers with two or more polymerizable double bonds that react at different rates during the polymerization. Preferably those compounds are used in which at least one reactive group polymerises at roughly the same rate as the remaining monomers, while the other reactive group (or reactive groups) polymerizes for example substantially more slowly. The different polymerization rates result in a certain proportion of unsaturated double bonds in the rubber. If a further phase is then grafted onto such a rubber, the double bonds present in the rubber react at least partially with the graft monomers to form chemical bonds, i.e. the grafted-on phase is at least partially linked via chemical bonds to the graft base.

Examples of such graft-linking monomers are monomers containing allyl groups, in particular allyl esters of ethylenically unsaturated carboxylic acids such as allyl acrylate, allyl methacrylate, diallyl maleate, diallyl fumarate, diallyl itaconate or the corresponding monoallyl compounds of these dicarboxylic acids. In addition there is a large number of further suitable graft-linking monomers, further details of which may be found for example in U.S. Pat, No. 4,148,846.

In general the proportion of these crosslinking monomers in the impact-resistant modifying polymer is up to 5 wt. %, preferably no more than 3 wt. %, referred to the impact-resistant modifying polymer.

Some preferred emulsion polymers are listed hereinbelow. Graft polymers with a core and at least one outer shell that have the following structure should first of all be mentioned here:

| | | Monomers for forming the |
|---|---|---|
| Type | Monomers for forming the Core | Cover |
| I | buta-1,3-diene, isoprene, n-butyl | styrene, acrylonitrile, methyl |
| | acrylate, ethyl hexacrylate or their | methacrylate |
| | mixtures | |
| II | as I but with the co-use of crosslinking | as I |
| | agents | |
| III | as I or II | n-butyl acrylate, ethyl acrylate, |
| | | methyl acrylate, buta-1,3- |
| | | diene, isoprene, ethylhexyl |
| | | acrylate |
| IV | as I or II | as I or III but with the co-use |
| | | of monomers containing |
| | | reactive groups as described |
| | | herein |
| V | styrene, acrylonitrile, methyl | first cover of monomers as |
| | methacrylate or their mixtures | described under I and II for |
| | | the core, second cover as |
| | | described under I or IV for the |
| | | cover |

These graft polymers, in particular ABS polymers and/or ASA polymers in amounts of up to 40 wt. %, are preferably used for the impact-resistant modification of PBT, optionally mixed with up to 40 wt. % of polyethylene terephthalate. Corresponding blend products are obtainable under the trade mark Ultradur®s (formerly Utrablend®S of BASF AG). ABS/ASA mixtures with polycarbonates are commercially available under the trade name Terlblend® (BASF AG).

Instead of graft polymers with a multi-shell structure, there may also be used homogeneous elastomers, i.e. single-shell elastomers of buta-1,3-diene, isoprene and n-butyl acrylate or their copolymers. These products too may be produced by the co-use of crosslinking monomers or monomers containing reactive groups.

Examples of preferred emulsion polymers are n-butyl acrylate/(meth)acrylic acid copolymers, n-butyl acrylate/glycidyl acrylate copolymers or n-butyl acrylate/glycidyl methacrylate copolymers, graft polymers with an inner core of n-butyl acrylate or based on butadiene and an outer cover of the aforementioned copolymers and copolymers of ethylene with comonomers that provide reactive groups.

The described elastomers may also be produced by other conventional methods, for example by suspension polymerization.

Silicone rubbers, as described in DE-A 37 25 576, EP-A 235 690, DE-A 38 00 603 and EP-A 319 290, are also preferred.

Mixtures of the types of rubbers listed above may also be employed.

As examples of antioxidants and thermal stabilizers there may be mentioned sterically hindered phenols and/or phosphites, hydroquinones, aromatic secondary amines such as diphenylamines, various substituted members of these groups and their mixtures in concentrations up to 1 wt. %, referred to the weight of the thermoplastic molding compositions.

As UV stabilizers, which may be used in amounts of up to 2 wt. %, referred to the molding composition, there may be mentioned various substituted resorcinols, salicylates, benzotriazoles and benzophenones.

Stabilizers also include metal salts and metal compounds having a stabilising effect, in which connection metal oxides, sulfides and borates, in particular zinc oxide, zinc sulfide, zinc borate as well as oxides of the lanthanides are preferred.

Inorganic pigments such as titanium dioxide, ultramarine blue, iron oxide and carbon black, and furthermore organic pigments such as phthalocyanines, quinacridones, perylenes as well as dyes such as nigrosine and anthraquinones may be added as colorants.

As nucleating agents there are used conventional nucleating agents in amounts of ≦1 wt. %, preferably ≦0.5 wt. %, particularly preferably ≦0.3 wt. % referred to the total molding composition, sodium phenylphosphinate, aluminium oxide, silicone dioxide and in particular talcum being preferred.

Lubricants and mold release agents, which are normally used in amounts of up to 1 wt. %, are preferably long-chain fatty acids (e.g. stearic acid or behenic acid), their salts (e.g. Ca or Zn stearate) as well as amide derivatives (e.g. ethylene-bis-stearylamide) or montan waxes (mixtures of straight-chain, saturated carboxylic acids with chain lengths of 28 to 32 C atoms) as well as low molecular weight polyethylene and polypropylene waxes.

As examples of plasticizers there may be mentioned dioctyl phthalate, dibenzyl phthalate, butylbenzyl phthalate, hydrocarbon oils and N-(n-butyl)-benzenesulfonamide. Polytetrafluoroethylene (PTFE), tetrafluoroethylenehexa-fluoropropylene copolymers or tetrafluoroethylene copolymers with relatively small proportions (as a rule up to 50 wt. %) of copolymerizable ethylenically unsaturated monomers may also be included. These are described for example by Schildknecht in “Vinyl and Related Polymers”, Wiley Publishers, 1952, pp. 484 to 494 and by Wall in “Fluoropolymers” (Wiley Interscience, 1972).

These fluorine-containing ethylene polymers are present in homogeneously distributed form in the molding compositions and preferably have a particle size d₅₀ (numerical average) in the range from 0.05 to 10 μm, in particular 0.1 to 5 μm. These small particle sizes may be achieved particularly preferably by using aqueous dispersions of fluorine-containing ethylene polymers and their incorporation into a polyester melt.

The thermoplastic molding compositions according to the invention may be produced by methods known per se, by mixing the starting components in conventional mixing equipment such as screw extruders, Brabender mills or Banbury mills, followed by extrusion. After the extrusion the extrudate may be cooled and comminuted. Individual components may also be premixed, followed by the addition of the remaining starting substances either individually and/or also mixed. The mixing temperatures are as a rule between 230° and 290° C.

According to a second procedure the components B) to D) as well as optionally conventional additives E) may be mixed with a polyester prepolymer, formulated, and granulated. The granular material that is obtained is then condensed continuously or batchwise in the solid phase under an inert gas at a temperature below the melting point of component A) until the desired viscosity is achieved.

The thermoplastic molding compositions according to the invention are characterised by good mechanical properties and good flameproofing properties and at the same time satisfy the incandescent wire test. The processing does not for the most part produce any change in the polymer matrix and mold deposits are greatly reduced. The molding compositions are suitable for the production of fibers, films and molded articles, in particular for applications in the electrical and electronics sector.

| | |
|---|---|
| Component A: | PBT Pocan ® B 1300 000000 (Bayer AG, Leverkusen, |
| | Germany) |
| Component B: | Melamine cyanurate (Melapur ® MC 25, DSM-Melapur, |
| | Heerlen, Holland) |
| Component C/1: | Bisphenol A disphosphate (Reofos ® BAPP, Great Lakes, |
| | West Lafayette, Indiana, USA) |
| Component C/2: | Triphenyl phosphate (Disflamoll ® TP, Bayer AG, |
| | Leverkusen, Germany) |
| Component D: | Montan glycol wax (E wax, Hoeschst, Frankfurt am M., |
| | Germany) |
| Component E/1: | Phosphit-Stabilizer, 10% in PBT Pocan ® B 1300 000000 |
| Component E/2: | Nucleating agent:Talkum |
| Component F (comparison example): | chopped glass fibers (CS 7962, Bayer AG, |
| | Leverkusen, Germany) |

| Test | 1(C) | 2 | 3 | 4(C) | 5(C) | 6(C) |
|---|---|---|---|---|---|---|
| A | 94.6 | 90.6 | 90.6 | 64.6 | 60.6 | 60.6 |
| B | 2.0 | 4.0 | 4.0 | 2.0 | 4.0 | 4.0 |
| C/1 | 2.0 | 4.0 | — | 2.0 | 4.0 | — |
| C/2 | — | — | 4.0 | — | — | 4.0 |
| D | 0.3 | 0.3 | 0.3 | 0.3 | 0.3 | 0.3 |
| E/1 | 1.0 | 1.0 | 1.0 | 1.0 | 1.0 | 1.0 |
| E/2 | 0.1 | 0.1 | 0.1 | 0.1 | 0.1 | 0.1 |
| F | — | — | — | 30 | 30 | 30 |
| IZOD impact | 99 | 79 | 78 | 39 | 41 | 47 |
| toughness | kJ/m² | kJ/m² | kJ/m² | kJ/m² | kJ/m² | kJ/m² |
| ISO 180/IU | | | | | | |
| 23° C. | | | | | | |
| UL94, 0.8 mm | Failed | V-2 | V-2 | Failed | Failed | Failed |
| Incandescent | 960° C. | 960° C. | 960° C. | 700° C. | 700° C. | 700° C. |
| wire test (IEC- | | | | | | |
| 695-2-1) | | | | | | |
| 2 mm | | | | | | |

Figures for the formulation composition are in weight percent

C- denotes a comparative example.

What is claimed is:

1. A thermoplastic molding composition consisting of
A) 55 to 93.99 wt. % of a or a mixture of polyester,
B) 3 to 15 wt. % of melamine cyanurate,
C) 3 to 15 wt. % of at least one phosphorus-containing flameproofing agent in which the valence of the phosphorus is −3 to +5,
D) 0.01 to 5 wt. % of at least one ester or amide of saturated or unsaturated aliphatic carboxylic acids with 10 to 40 C atoms with aliphatic saturated alcohols or amines with 2 to 40 C atoms,
E) 0 to 10 wt. % of at least one member selected from the group consisting of stabilizers, antioxidants, thermal stabilizers, UV stabilizers, lubricants, mold release agents, rubber-elastic polymers, colorants, , nucleating agents and plasticizers,
in which the total sum of the percentages by weight of the components A) to E) is 100%, the composition excluding reinforcing agents and fillers selected from the group consisting of mineral, carbon and glass fiber-shaped particulates and spherical particulates and amorphous silicic acid.

2. The molding composition according to claim 1, wherein flameproofing agent C) conforms to formula (I) 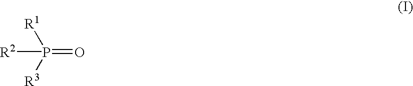
in which
R¹, R² and R³ independently denote alkyl, aryl, alkylaryl or cycloalkyl groups with 8 to 40 C atoms.

3. Themolding composition according to claim 1, wherein the flameproofing agent C) conforms to the formula 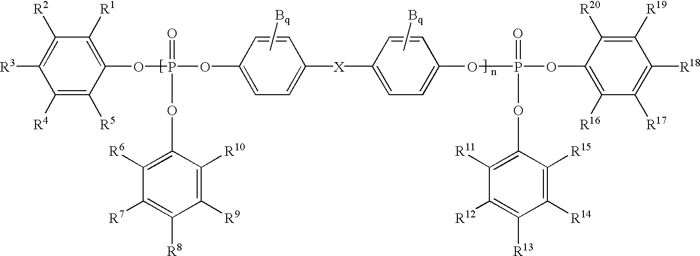
wherein
R¹ to R²⁰ independently of one another denote hydrogen, a linear or branched alkyl group with up to 6 C atoms,
n has an average value of 0.5 to 50, and
B denotes C₁ to C₁₂-alkyl, or halogen,
q independently of one another is 0, 1 or 2,
X denotes a single bond, C═O, S, O, SO₂, C(CH₃)₂, C₁ to C₅-alkylene, C₂ to C₅-alkylidene, C₅ to C₆-cycloalkylidene, C₆ to C₁₂-arylene, onto which further aromatic rings optionally containing heteroatoms may be condensed, or denotes a radical of the formula (II) or (III) 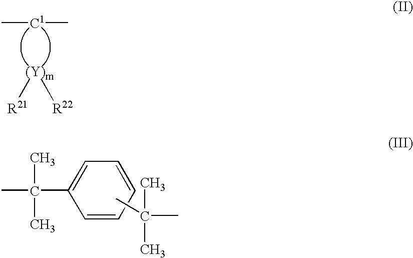
where Y denotes carbon and
R²¹ and R²², are selected individually for each Y, and independently of one another denote hydrogen or C₁ to C₆-alkyl,
m is an integer of 4 to 7, with the proviso that on at least one Y atom, R²¹ and R²² are simultaneously alkyl.

4. The molding composition according to claim 1 in which the component C) is at least one member selected from the group consisting of triphenyl phosphine oxide, triphenyl phosphine sulfide, triphenyl phosphate, resorcinol-bis(diphenyl phosphate), triphenyl phosphine and bisphenol A diphosphate.

5. The molding composition according to claim 1 in which the component D) is a member selected from the group consisting of pentaerythritol tetrastearate and ethylene glycol bismontanoate.

6. The molding composition according to claim 1 in which the component A) is polybutylene terephthalate.

7. The molding composition according to claim 1 in which the component A) is a mixture of polyethylene terephthalate and polybutylene terephthalate.

8. The molding composition according to claim 7 in which the proportion of polyethylene terephthalate in the mixture is 10 to 30 wt. %.

9. The molding composition according to claim 7 in which the polyethylene terephthalate consists of a recyclate having a residual moisture content of 0.01 to 0.7%.

10. A process of using the molding compositions according to claim 1 comprising producing a member selected from the group consisting of fibers, films and molded articles.

11. A molded article comprising the composition of claim 1.
